(19) United States
(12) Patent Application Publication
(10) Pub. No.: US 2026/0211411 A1
(43) Pub. Date: Jul. 23, 2026

(54) EQUIPMENT STATE ESTIMATION DEVICE AND EQUIPMENT STATE ESTIMATION METHOD

(71) Applicant: Panasonic Intellectual Property Management Co., Ltd., Osaka (JP)

(72) Inventors: Tenta KOMATSU, Osaka (JP); Naganori SHIRAKATA, Osaka (JP)

(73) Assignee: Panasonic Intellectual Property Management Co., Ltd., Osaka (JP)

(21) Appl. No.: 19/139,632

(22) PCT Filed: Nov. 13, 2023
(86) PCT No.: PCT/JP2023/040747

§ 371 Date: Jun. 16, 2025

(30) Foreign Application Priority Data
Dec. 26, 2022 (JP) 2022-209009

(51) Int. Cl. G05B 23/02

(52) U.S. Cl. CPC G05B 23/0254

(57) ABSTRACT

An equipment state estimation device includes: a determiner that determines whether a real measurement signal obtained by measuring an operation state of equipment is normal or anomalous; a simulator that generates an anomalous period generated signal by simulating an anomaly in the equipment; a compositor that generates an anomalous period composite signal by compositing the anomalous period generated signal with a normal period real measurement signal that is a real measurement signal determined to be normal by the determiner; a learner that generates a learning model by performing machine learning using the anomalous period composite signal; and a estimator that estimates an anomaly location in the equipment based on the learning model and an anomalous period real measurement signal that is a real measurement signal determined to be anomalous by the determiner. The simulator generates the anomalous period generated signal using the anomalous period composite signal.

### TECHNICAL FIELD

The present disclosure relates to an equipment state estimation device and an equipment state estimation method.

### BACKGROUND ART

A large number of motors or gears are used in industrial equipment, industrial machines, industrial robots, power generation equipment, and the like for production in factories and the like. Anomalies occurring in equipment due to age and/or deterioration from wear, not to mention sudden problems in devices, cause lines to stop. Reduced productivity or accidents associated with such stops are also a concern.

What is needed, therefore, is a method that uses machine learning models or the like to estimate internal states of equipment from the features of signals from sensors mounted on the equipment, to enable efficient scheduled maintenance according to the state of the equipment.

Recent years in particular have seen increased demand not only for technologies that estimate whether equipment is normal or experiencing an anomaly, but also technologies that estimate anomaly locations, for the purpose of fully automating maintenance tasks.

A lack of anomalous period data is a technical issue which arises when estimating anomaly locations in addition to whether equipment is normal or experiencing an anomaly.

When estimating only whether equipment is normal or experiencing an anomaly, it is sufficient to learn only the features of normal period data, which can be obtained in large quantities, and evaluate differences from normal periods. However, anomalous period data corresponding to respective anomaly locations is necessary when estimating anomaly locations. However, an amount of anomalous period data sufficient for learning can rarely be obtained from equipment on site.

In response to this, Patent Literature (PTL) 1 to 3 disclose techniques for generating data by performing simulations.

PTL 1, for example, discloses using artificial intelligence (AI) processing to learn relationships between parameters computed when a simulator reproduces an anomalous phenomenon, and the anomalous phenomenon.

PTL 2 discloses generating, based on a physical model, simulated data corresponding to historical data of anomalous operating modes. PTL 2 further discloses updating parameters of the physical model based on differences between simulated data and experimental data.

PTL 3 discloses generating an artificial signal constituted by a voltage waveform indicating an anomaly. PTL 3 also discloses generating a simulation signal by compositing an artificial signal with a real signal obtained from a real device.

### CITATION LIST

### Patent Literature

[PTL 1] Japanese Unexamined Patent Application Publication No. 2022-20555
[PTL 2] Japanese Unexamined Patent Application Publication No. 2018-10636
[PTL 3] Japanese Unexamined Patent Application Publication No. 2016-50826

### SUMMARY OF INVENTION

### Technical Problem

The present disclosure provides an equipment state estimation device and an equipment state estimation method capable of accurately estimating the location of an anomaly in equipment.

### Solution to Problem

An equipment state estimation device according to one aspect of the present disclosure includes: a determiner that determines whether a real measurement signal obtained by measuring an operation state of equipment is normal or anomalous; a simulator that generates an anomalous period generated signal by simulating an anomaly in the equipment; a compositor that generates an anomalous period composite signal by compositing the anomalous period generated signal with a normal period real measurement signal that is a real measurement signal determined to be normal by the determiner; a learner that generates a learning model for estimating an anomaly location in the equipment by performing machine learning using the anomalous period composite signal; and a first estimator that estimates the anomaly location in the equipment based on the learning model and an anomalous period real measurement signal that is a real measurement signal determined to be anomalous by the determiner, wherein the simulator generates the anomalous period generated signal using the anomalous period composite signal.

An equipment state estimation method according to one aspect of the present disclosure includes: determining whether a real measurement signal obtained by measuring an operation state of equipment is normal or anomalous; generating an anomalous period generated signal by simulating an anomaly in the equipment; generating an anomalous period composite signal by compositing the anomalous period generated signal with a normal period real measurement signal that is a real measurement signal determined to be normal; generating a learning model for estimating an anomaly location in the equipment by performing machine learning using the anomalous period composite signal; and estimating the anomaly location in the equipment based on the learning model and an anomalous period real measurement signal that is a real measurement signal determined to be anomalous, wherein the generating of the anomalous period generated signal includes generating the anomalous period generated signal using the anomalous period composite signal.

Note that these comprehensive or specific aspects may be realized by a system, a method, an integrated circuit, a computer program, or a recording medium, or may be implemented by any desired combination of systems, devices, methods, integrated circuits, computer programs, and recording media.

### Advantageous Effects of Invention

According to one aspect of the present disclosure, the location of an anomaly in equipment can be estimated accurately.

### BRIEF DESCRIPTION OF DRAWINGS

FIG. 1 is a block diagram illustrating the configuration of an equipment state estimation system according to an embodiment.

FIG. 2 is a block diagram illustrating the configuration of a composite signal generator of the equipment state estimation device according to the embodiment.

FIG. 3 is a flowchart illustrating an example of operations performed by the equipment state estimation device according to the embodiment.

FIG. 4 is a flowchart illustrating processing pertaining to parameter identification among operations performed by the equipment state estimation device according to the embodiment.

FIG. 5 is a diagram illustrating an example of an anomalous period generated signal generated by a simulator of the equipment state estimation device according to the embodiment.

FIG. 6 is a flowchart illustrating processing pertaining to signal compositing among operations performed by the equipment state estimation device according to the embodiment.

FIG. 7 is a diagram illustrating an example of an anomalous period composite signal generated by a compositor of the equipment state estimation device according to the embodiment.

FIG. 8 is a diagram illustrating an example of a physical parameter input/output screen displayed by an input acceptor/outputter of the equipment state estimation device according to the embodiment.

FIG. 9 is a diagram illustrating an example of a screen displaying a GUI object for inputting a compositing ratio and a compositing result, displayed by the input acceptor/outputter of the equipment state estimation device according to the embodiment.

### DESCRIPTION OF EMBODIMENTS

### Underlying Knowledge Forming Basis of Present Disclosure

The inventors of the present disclosure discovered that the past techniques described above in the Background section have the following problems.

In general, it is difficult to accurately understand physical parameters used in a simulation. Simulation errors are therefore more likely to arise in data generated by the simulation. With the technique disclosed in PTL 1, anomalies may be falsely detected, or normal and anomalous operations may be misclassified.

In addition, with the technique disclosed in PTL 2, updating the parameters of the physical model may make it possible to bring the values of the parameters closer to the actual values. However, the features of the data produced by phenomena not taken into account by the simulation model cannot be reproduced to begin with. A simulation model that takes into account all physical phenomena that may arise in equipment cannot be constructed in advance. The technique disclosed in PTL 2 therefore may also produce false detections or misclassifications.

With the technique disclosed in PTL 3, the real signal and the artificial signal are composited, and thus the features of data produced by phenomena not taken into account by the simulation model can be incorporated into the simulation data. However, the features of non-linear data such as that which arises due to overlap between the features of the artificial signal generated through simulation and features specific to the real signal cannot be reproduced.

In this manner, the techniques disclosed in PTL 1 to 3 cannot accurately estimate the location of an anomaly in equipment.

To address the foregoing issue, an equipment state estimation device according to a first aspect of the present disclosure includes: a determiner that determines whether a real measurement signal obtained by measuring an operation state of equipment is normal or anomalous; a simulator that generates an anomalous period generated signal by simulating an anomaly in the equipment; a compositor that generates an anomalous period composite signal by compositing the anomalous period generated signal with a normal period real measurement signal that is a real measurement signal determined to be normal by the determiner; a learner that generates a learning model for estimating an anomaly location in the equipment by performing machine learning using the anomalous period composite signal; and a first estimator that estimates the anomaly location in the equipment based on the learning model and an anomalous period real measurement signal that is a real measurement signal determined to be anomalous by the determiner, wherein the simulator generates the anomalous period generated signal using the anomalous period composite signal.

In this manner, the simulator generates the anomalous period generated signal having received feedback (specifically, the anomalous period composite signal) from the compositor, and thus the features of non-linear data, such as that which arises due to overlap between the features of artificial signals generated through simulation and features specific to real signals, can also be reproduced. As such, the reliability of anomalous period composite signals that can be used as training data in machine learning is increased, and the diversification thereof is also possible, which makes it possible to increase the accuracy of the learning model. Thus, according to the equipment state estimation device according to this aspect, the location of an anomaly in the equipment can be estimated with high accuracy.

Further advantages and effects of one aspect of the present disclosure will become apparent from the specification and the drawings. While such advantages and/or effects are provided by some embodiments and the features described or illustrated in the specification and the drawings, not all need be provided to achieve one or more of the same features.

Additionally, according to an equipment state estimation device according to a second aspect of the present disclosure, the equipment state estimation device according to the first aspect further includes: a second estimator that estimates a frequency and a phase of a harmonic component included in the normal period real measurement signal as a first frequency and a first phase; and an identifier that identifies a first physical parameter of the equipment based on the first frequency and the first phase, wherein the simulator performs the simulating using the first physical parameter identified by the identifier.

Through this, the physical parameters can be identified accurately by utilizing the frequency and phase of the harmonic component. For example, by using only the frequency and the phase, the physical parameters can be identified accurately while suppressing an increase in the amount of computation required for identification.

Additionally, according to an equipment state estimation device according to a third aspect of the present disclosure, in, for example, the equipment state estimation device according to the second aspect, the second estimator further estimates a frequency and a phase of a harmonic component included in the anomalous period generated signal as a second frequency and a second phase, and the identifier identifies the first physical parameter to cause a frequency difference and a phase difference to each be less than a corresponding threshold, the frequency difference being a difference between the first frequency and the second frequency, and the phase difference being a difference between the first phase and the second phase.

Through this, by reducing the frequency difference and phase difference to less than the corresponding thresholds, the reproducibility of non-linear data, such as that which arises due to overlap between features specific to the artificial signal and features specific to the real signal, can be improved when the composite signal is generated.

Additionally, according to an equipment state estimation device according to a fourth aspect of the present disclosure, for example, the equipment state estimation device according to the second or third aspect further includes: an input acceptor that accepts an input of a search range for the first physical parameter, wherein the identifier identifies the first physical parameter within the search range.

Through this, a search range can be set, which makes it possible to avoid searching up to values which clearly cannot be taken on. This in turn makes it possible to suppress an increase in the amount of computation.

Additionally, according to an equipment state estimation device according to a fifth aspect of the present disclosure, in, for example, the equipment state estimation device according to the fourth aspect, the input acceptor accepts an input of a value of a second physical parameter of a type different from the first physical parameter, and the second estimator estimates the first frequency and the first phase using the value accepted by the input acceptor.

Through this, the values of physical parameters that do not need to be searched can be set. Accepting the input of two types of physical parameters, namely the physical parameters that need to be searched and the physical parameters that have been determined, eliminates the need to search all physical parameters, which makes it possible to suppress an increase in the amount of computation and complexity of the simulation.

Additionally, according to an equipment state estimation device according to a sixth aspect of the present disclosure, for example, the equipment state estimation device according to the fourth or fifth aspect further includes an outputter that outputs the first physical parameter identified by the identifier.

Through this, the physical parameter identification result can be presented to the user, and the user can therefore evaluate the validity of the identification result. For example, if the identification result is not valid, the physical parameters can be identified again. As such, highly-accurate physical parameters can be identified, which makes it possible to increase the accuracy of the simulation.

Additionally, according to an equipment state estimation device according to a seventh aspect of the present disclosure, in, for example, the equipment state estimation device according to any one of the fourth to sixth aspects, the input acceptor accepts an input of a setting range for an anomalous parameter of the equipment, and the simulator generates the anomalous period generated signal by performing the simulating within the setting range for the anomalous parameter.

Through this, simulations which go as far as anomalies which are clearly unlikely to occur can be avoided by setting the setting range for the anomaly parameter, which makes it possible to suppress an increase in the amount of computation.

Additionally, according to an equipment state estimation device according to an eighth aspect of the present disclosure, in, for example, the equipment state estimation device according to any one of the first to seventh aspects, by performing the simulating using the anomalous period composite signal from a first time, the simulator generates the anomalous period generated signal for a second time that is a predetermined period after the first time.

Through this, the anomalous period generated signal can be generated while receiving feedback of the anomalous period composite signal every predetermined period. Accordingly, the reproducibility of non-linear data, such as that which arises due to overlap between features specific to artificial signals and features specific to real signals, can be improved.

Additionally, according to an equipment state estimation device according to a ninth aspect of the present disclosure, for example, the equipment state estimation device according to any one of the first to eighth aspects further includes: an input acceptor that accepts an input of a compositing ratio between the normal period real measurement signal and the anomalous period generated signal, wherein the compositor generates the anomalous period composite signal by compositing the normal period real measurement signal and the anomalous period generated signal at the compositing ratio.

Through this, the compositing ratio can be set such that a highly reliable anomalous period composite signal can be obtained. As such, the reliability of the training data can be increased, which makes it possible to increase the accuracy of the learning model and to estimate the locations of anomalies in the equipment with high accuracy.

Additionally, according to an equipment state estimation device according to a tenth aspect of the present disclosure, for example, the equipment state estimation device according to any one of the first to ninth aspects further includes an outputter that outputs the normal period real measurement signal, the anomalous period generated signal, and the anomalous period composite signal.

Through this, by outputting and presenting each signal to the user, the user can evaluate the validity of the anomalous period generated signal and the anomalous period composite signal. For example, if the anomalous period generated signal or the anomalous period composite signal is not valid, the signal can be generated or composited again. As such, the reliability of the training data can be increased, which makes it possible to increase the accuracy of the learning model and to estimate the locations of anomalies in the equipment with high accuracy.

Additionally, an equipment state estimation method according to an eleventh aspect of the present disclosure includes: determining whether a real measurement signal obtained by measuring an operation state of equipment is normal or anomalous; generating an anomalous period generated signal by simulating an anomaly in the equipment; generating an anomalous period composite signal by compositing the anomalous period generated signal with a normal period real measurement signal that is a real measurement signal determined to be normal; generating a learning model for estimating an anomaly location in the equipment by performing machine learning using the anomalous period composite signal; and estimating the anomaly location in the equipment based on the learning model and an anomalous period real measurement signal that is a real measurement signal determined to be anomalous, wherein the generating of the anomalous period generated signal includes generating the anomalous period generated signal using the anomalous period composite signal.

Through this, an anomaly location in the equipment can be estimated with high accuracy, as with the equipment state estimation device described above.

Additionally, a program according to a twelfth aspect of the present disclosure is a program that causes a computer to execute the equipment state estimation method according to the eleventh aspect.

Through this, an anomaly location in the equipment can be estimated with high accuracy, as with the equipment state estimation device described above.

Additionally, one aspect of the present disclosure can also be realized as a non-transitory computer-readable recording medium having the program recorded thereon.

An embodiment of the present disclosure will be described in detail hereinafter with reference to the drawings.

Note that the following embodiment describes comprehensive or specific examples of the present disclosure, and the present disclosure is not intended to be limited by the following embodiment. The numerical values, shapes, materials, constituent elements, arrangements and connection states of constituent elements, steps, orders of steps, and the like in the following embodiment are merely examples, and are not intended to limit the present disclosure. Additionally, of the constituent elements in the following embodiment, constituent elements not denoted in the independent claims will be described as optional constituent elements.

Additionally, the drawings are schematic diagrams, and are not necessarily exact illustrations. As such, the scales and the like, for example, are not necessarily consistent from drawing to drawing. Furthermore, configurations that are substantially the same are given the same reference signs in the drawings, and redundant descriptions will be omitted or simplified.

In addition, in the present specification, unless otherwise specified, ordinals such as “first” and “second” do not refer to the number or order of the constituent elements, and are rather used for the purpose of avoiding confusion and distinguishing between constituent elements of the same kind.

### Embodiment

### [1. Configuration]

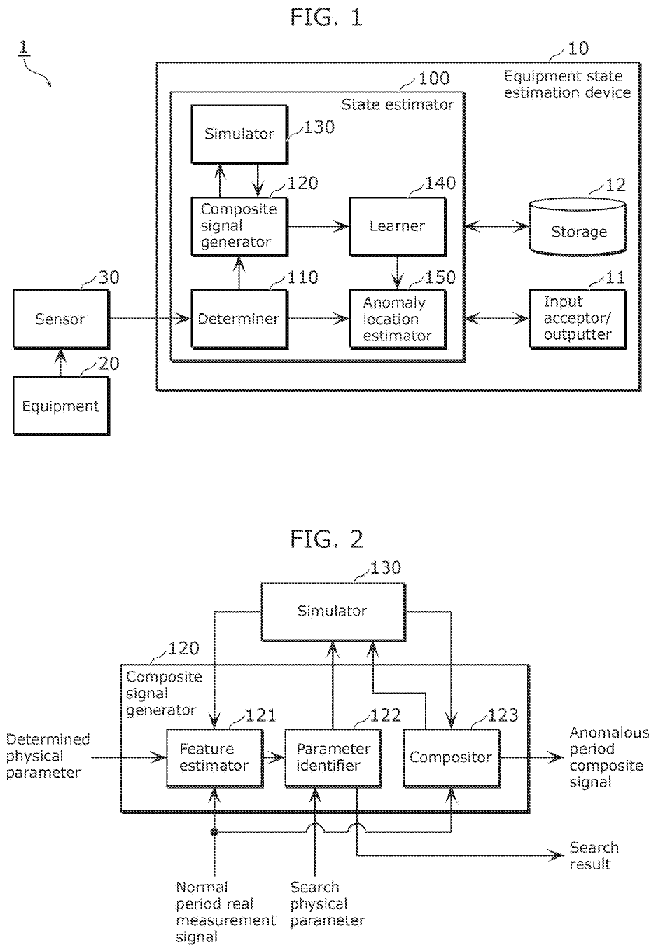

An overview of the configuration of and processing by an equipment state estimation system will be described first with reference to FIG. 1.

FIG. 1 is a block diagram illustrating the configuration of equipment state estimation system 1 according to the present embodiment. As illustrated in FIG. 1, equipment state estimation system 1 includes equipment state estimation device 10, equipment 20, and sensor 30.

Equipment state estimation device 10 is a device that estimates an operating state of equipment 20. Specifically, equipment state estimation device 10 detects an anomaly in equipment 20 and estimates an anomaly location of the detected anomaly. The anomaly location is information expressing the site where the anomaly has occurred, the cause of the anomaly, and/or the severity of the anomaly.

As illustrated in FIG. 1, equipment state estimation device 10 includes input acceptor/outputter 11, storage 12, and state estimator 100. State estimator 100 includes determiner 110, composite signal generator 120, simulator 130, learner 140, and anomaly location estimator 150. The specific processing by each constituent element of equipment state estimation device 10 will be described later.

Equipment 20 is a machine subject to state estimation.

Equipment 20 is a rotary machine such as a motor or generator, for example. Alternatively, equipment 20 may be a mechanism in which a plurality of rotary machines are connected by a gearbox, loads, chains, or the like, or may be a mechanism such as a robot arm or a mobile body having a plurality of rotary machines built in.

Sensor 30 measures a physical quantity such as vibrations, electromagnetic waves, and/or heat generated in equipment 20, and converts the measured physical quantity into a signal that can be processed as electronic information. Sensor 30 outputs the signal obtained from the conversion to determiner 110 of equipment state estimation device 10. Sensor 30 is incorporated into equipment 20, for example, but is not limited thereto.

Note that equipment state estimation system 1 may include a plurality of sensors 30. For example, a plurality of sensors 30 measure physical quantities at different measurement sites of equipment 20. Additionally, the plurality of sensors 30 may measure physical quantities having different types from one another.

### [1-1. Equipment State Estimation Device]

The constituent elements of equipment state estimation device 10 will be described next.

Input acceptor/outputter 11 accepts inputs from a user, such as setting information used to identify parameters and composite data. Input acceptor/outputter 11 also outputs information such as parameter search results, the estimated state of equipment, and the like. In the present embodiment, input acceptor/outputter 11 has a display function that visualizes information and presents that information to the user. Note that the user is an administrator of equipment state estimation system 1, a manager of or worker using equipment 20, or the like, but is not particularly limited.

Input acceptor/outputter 11 is implemented by an integrated input/output device having an input function and a display function, such as a touchscreen, for example. Note that the information output by input acceptor/outputter 11 may be audio output instead of or in addition n to being displayed. Alternatively, input acceptor/outputter 11 may have a communication function that outputs information to another device (e.g., a mobile terminal or a display device).

Input acceptor/outputter 11 may be implemented by two or more devices including an input device and an output device. The input device is a keyboard, a mouse, a touch sensor, a microphone, or the like, for example. The output device is a display device, a speaker, a communication interface device, or the like, for example.

Storage 12 stores information and data such as programs used by state estimator 100. Storage 12 also stores information generated by state estimator 100 and data such as machine learning models. Storage 12 is implemented as a non-volatile storage device, such as a Hard Disk Drive (HDD) or a Solid State Drive (SSD).

Storage 12 need not be provided in equipment state estimation device 10. For example, storage 12 may be provided in an external server device or the like accessible by state estimator 100.

State estimator 100 detects an anomaly in equipment 20 based on the setting information input from input acceptor/outputter 11, a signal obtained from sensor 30, and information read out from a database stored in storage 12. When an anomaly is detected in equipment 20, state estimator 100 estimates an anomaly location using a learning model. State estimator 100 outputs various information, such as anomaly detection results and anomaly location estimation results, to input acceptor/outputter 11.

State estimator 100 is implemented by a computer device including a processor, for example. For example, the computer device includes non-volatile memory in which programs are stored, volatile memory that is a temporary storage region for executing the programs, input/output ports, a processor that executes the programs, and the like. The programs executed by the processor may be stored in storage 12. Each processing unit provided in state estimator 100 is implemented as software by the processor. Alternatively, each processing unit provided in state estimator 100 may be implemented by hardware such as a dedicated or general-purpose integrated circuit.

Determiner 110 determines whether a real measurement signal obtained by measuring an operation state of equipment 20 is normal or anomalous. A real measurement signal being “normal” means that equipment 20 subject to measurement by sensor 30 is in a normal state. A real measurement signal being “anomalous” means that equipment 20 is in an anomalous state. In other words, in the present embodiment, determiner 110 determines whether equipment 20 is in a normal state or an anomalous state using a real measurement signal input from sensor 30.

A machine learning model that has learned features of normal period real measurement signals may be used in the determination, for example. For machine learning, various publicly-known algorithms can be used, such as autoencoders based on neural networks, support vector machines, random forests, and ensemble learning that combines these methods, for example.

Determiner 110 assigns a label of “normal period” or “anomalous period” to the real measurement signal based on the determination result. Determiner 110 outputs the normal period real measurement signal, which is a real measurement signal determined to be normal, to composite signal generator 120. On the other hand, determiner 110 outputs an anomalous period real measurement signal, which is a real measurement signal determined to be anomalous, to anomaly location estimator 150.

Composite signal generator 120 generates an anomalous period composite signal. The anomalous period composite signal is a signal assumed to be output when equipment 20 is experiencing an anomaly, and is used for machine learning by learner 140. Specifically, anomalous period composite signal is a signal generated by compositing the normal period real measurement signal input from determiner 110 with the anomalous period generated signal input from simulator 130. By performing compositing, features based on actual measurements not taken into account in simulations can be included in the anomalous period composite signal, which makes it possible to increase the accuracy of the machine learning.

Composite signal generator 120 outputs physical parameters to simulator 130. Composite signal generator 120 assigns a label indicating the anomaly location to the anomalous period composite signal in accordance with simulation conditions, and outputs the labeled signal to learner 140. Composite signal generator 120 outputs the generated anomalous period composite signal to simulator 130. The specific configuration of and processing by composite signal generator 120 will be described later.

Simulator 130 generates the anomalous period generated signal by simulating an anomaly in equipment 20. Specifically, simulator 130 generates the anomalous period generated signal based on the physical parameters and signals provided by composite signal generator 120. The simulation may use an equivalent circuit model using a dq transform, a more detailed Finite Element Method (FEM) model, or a behavioral model in which the dimensions of the FEM model have been reduced, for example. Simulator 130 outputs the generated anomalous period generated signal to composite signal generator 120.

In the present embodiment, simulator 130 generates the anomalous period generated signal using the anomalous period composite signal input from composite signal generator 120. In other words, simulator 130 performs the simulation having received feedback from composite signal generator 120, and generates the anomalous period generated signal. The specific processing by which the anomalous period generated signal is generated will be described later.

Learner 140 generates a learning model for estimating an anomaly location in equipment by performing machine learning using the anomalous period composite signal output from composite signal generator 120. Specifically, learner 140 learns the features of the anomalous period composite signal and generates an anomaly location estimation model, which is an example of a learning model. Alternatively, the normal period real measurement signal and the anomalous period real measurement signal may be used in conjunction with the anomalous period composite signal in the learning.

The anomaly location estimation model is a mathematical model that takes a signal as an input and outputs an anomaly location. For learning the features of the anomalous period composite signal, autoencoders based on neural networks, support vector machines, random forests, ensemble learning that combines these methods, or the like can be used, for example. Learner 140 outputs the generated anomaly location estimation model to anomaly location estimator 150.

Anomaly location estimator 150 is an example of a first estimator, and estimates the anomaly location in equipment 20 based on the anomalous period real measurement signal output from determiner 110 and the anomaly location estimation model output from learner 140. Specifically, anomaly location estimator 150 estimates the anomaly location in equipment 20 by evaluating the anomalous period real measurement signal using the anomaly location estimation model. In other words, anomaly location estimator 150 diagnoses the anomaly location in equipment 20. Anomaly location estimator 150 outputs the estimation result (diagnosis result) to input acceptor/outputter 11. The estimation result is presented to the user through input acceptor/outputter 11.

### [1-2. Composite Signal Generator]

An example of the configuration of composite signal generator 120 according to the present embodiment will be described next with reference to FIG. 2. FIG. 2 is a block diagram illustrating the configuration of composite signal generator 120 of equipment state estimation device 10 according to the present embodiment. As illustrated in FIG. 2, composite signal generator 120 includes feature estimator 121, parameter identifier 122, and compositor 123.

Feature estimator 121 is an example of a second estimator, and estimates a plurality of features of an input signal. The plurality of features include a frequency and a phase of a harmonic component present in the signal. Specifically, feature estimator 121 estimates a frequency and a phase of a harmonic component included in the normal period real measurement signal input from determiner 110 as a first frequency and a first phase. Feature estimator 121 also estimates a frequency and a phase of a harmonic component included in the anomalous period generated signal input from simulator 130 as a second frequency and a second phase. Feature estimator 121 outputs the calculated frequency and phase to parameter identifier 122.

The harmonic component may be a harmonic component produced by rotation, for example. Here, a harmonic component produced by rotation is a harmonic component detected by sensor 30 due to rotation of a rotary mechanism such as a motor provided in equipment 20.

Physical parameters required for estimating the frequency and phase of the harmonic component produced by rotation are provided by the user as “determined physical parameters”, through input acceptor/outputter 11, for example. The determined physical parameter is an example of a second physical parameter of equipment 20. The determined physical parameter is a parameter having a value that can be understood by the user in advance according to the features of equipment 20 and the type of sensor 30. For example, when sensor 30 is a current sensor, the power supply frequency, the number of poles, the number of rotor bars, and the like are used as determined physical parameters. The determined physical parameter may be stored in storage 12 in advance. The determined physical parameter is also used in simulations by simulator 130.

Parameter identifier 122 identifies a “search physical parameter” of equipment 20. The search physical parameter is an example of a first physical parameter of equipment 20 and is of a type different from the determined physical parameter. A search physical parameter is a parameter having a value which is not determined according to the operation state of equipment 20, or which cannot be measured by sensor 30. For example, search physical parameters are rotor bar resistance, motor radius, and the like. Parameter identifier 122 identifies a search physical parameter specified by the user through input acceptor/outputter 11. The user sets a search range (upper limit value and lower limit value) of the search physical parameter through input acceptor/outputter 11.

Parameter identifier 122 identifies the search physical parameter based on the frequency and a phase input from feature estimator 121. Specifically, parameter identifier 122 identifies the search physical parameter such that a frequency difference between the frequency of the normal period real measurement signal (the first frequency) and the frequency of the anomalous period generated signal (the second frequency) and the phase difference between the phase of the normal period real measurement signal (the first phase) and the phase of the anomalous period generated signal (the second phase) are each less than a threshold. Parameter identifier 122 outputs the value of the identified search physical parameter to simulator 130. The search physical parameter is used in simulations by simulator 130.

Parameter identifier 122 also determines an “anomalous physical parameter” of equipment 20. The anomalous physical parameter is an example of a third physical parameter of equipment 20 and is a physical parameter corresponding to an anomaly location in equipment 20. For example, anomalous physical parameters are the number of damaged rotor bars, the depth of a crack in a bearing, the depth of a crack in a gear, and the like. Parameter identifier 122 determines the value of the anomalous physical parameter within a setting range for the anomalous physical parameter set by the user through input acceptor/outputter 11.

Compositor 123 generates the anomalous period composite signal by compositing the normal period real measurement signal output from determiner 110 with the anomalous period generated signal input from simulator 130. The compositing is performed through weighted averaging as indicated in Formula (1) below, for example.

$${I}_{fusion} ( t ) = r \times {I}_{sim} ( t ) + ( 1 - r ) \times {I}_{real} ( t ) \qquad ( 1 )$$

Here, time t is an example of a first time, and 0 can be used as an initial value, for example. I_{fusion}(t) is the anomalous period composite signal at time t. Iₛᵢₘ(t) is the anomalous period generated signal at time t. Iᵣₑₐₗ(t) is the normal period real measurement signal at time t. r is a compositing ratio.

Compositing ratio r is input through input acceptor/outputter 11, for example. Alternatively, compositing ratio r may be stored in storage 12 as a predetermined fixed value. Compositor 123 outputs the generated anomalous period composite signal to learner 140 and input acceptor/outputter 11. Compositor 123 also outputs the generated anomalous period composite signal to simulator 130 as feedback.

The method by which compositor 123 composites the normal period real measurement signal and the anomalous period generated signal is not limited to the foregoing method. For example, compositor 123 may sample the compositing ratio from a normal distribution such that compositing ratio r input from the user is the average, and use the sampled ratio. Alternatively, compositor 123 may use compositing ratio r input from the user as the initial value, and then dynamically calculate and use a compositing ratio by evaluating the difference between the normal period real measurement signal and the anomalous period generated signal in each simulation step.

The compositing by compositor 123 is what is known as “data assimilation”. In other words, the features of the normal period real measurement signal are assimilated to the anomalous period generated signal. As a result, the anomalous period composite signal after the compositing can include features based on phenomena not taken into account in the simulation.

### [2. Operations]

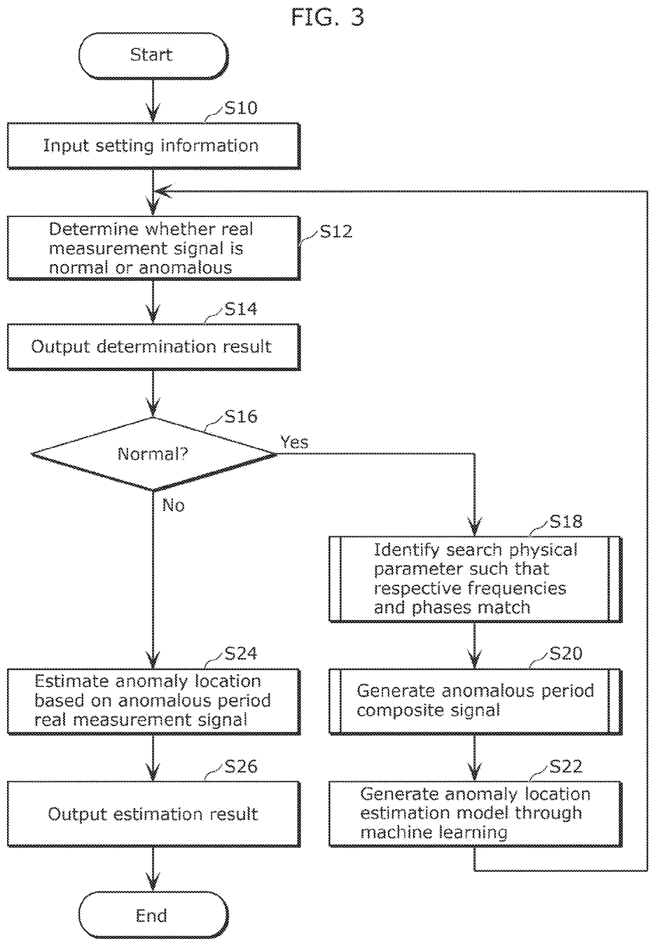

Operations by equipment state estimation device 10 according to the present embodiment will be described next. An example of the overall operations by equipment state estimation device 10 will be described first with reference to FIG. 3. FIG. 3 is a flowchart illustrating an example of operations performed by equipment state estimation device 10 according to the present embodiment.

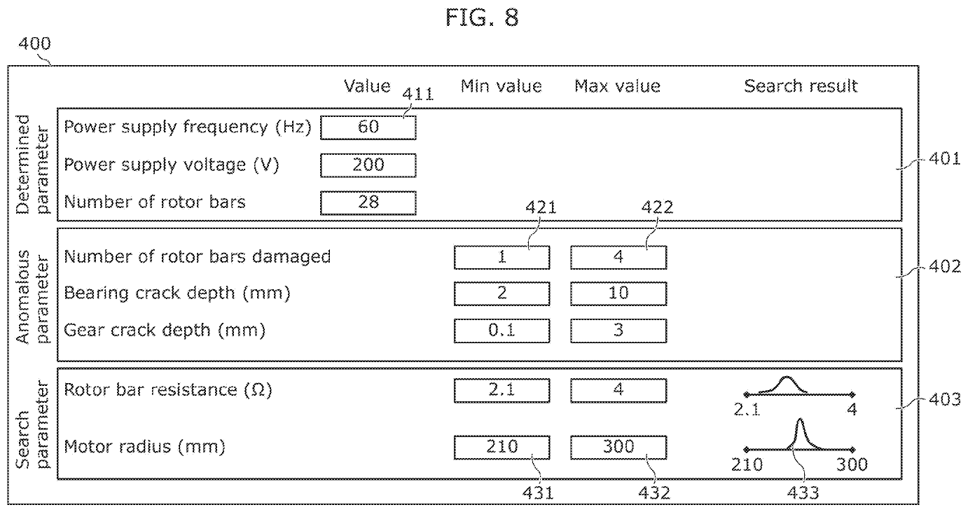

As illustrated in FIG. 3, first, input acceptor/outputter 11 accepts the input of the setting information necessary for the processing by state estimator 100 (S10). Specifically, input acceptor/outputter 11 accepts inputs such as the value of one or more determined physical parameters, a search range for one or more search physical parameters, a setting range for one or more anomalous physical parameters, and the like. A specific example of the input will be described later with reference to FIG. 8.

Next, determiner 110 determines whether a real measurement signal obtained by measuring an operation state of equipment 20 is normal or anomalous (S12). Specifically, sensor 30 measures a physical quantity of equipment 20, such as vibration and/or current, and outputs a real measurement signal to equipment state estimation device 10. Determiner 110 of state estimator 100 obtains the real measurement signal output from sensor 30 and determines whether the obtained real measurement signal is normal or anomalous, i.e., determines whether equipment 20 is in a normal state or an anomalous state. Determiner 110 assigns a label of either “normal” or “anomalous” to the real measurement signal based on the determination result. Determiner 110 outputs the normal period real measurement signal to composite signal generator 120. Determiner 110 outputs the anomalous period real measurement signal to anomaly location estimator 150. Determiner 110 also outputs the normal period real measurement signal and the anomalous period real measurement signal to input acceptor/outputter 11.

Note that a plurality of real measurement signals may be output from sensor 30, and in this case, the determination of normal or anomalous (S12) and the subsequent processing are performed for each of the plurality of real measurement signals.

Next, input acceptor/outputter 11 outputs the determination result (S14). Specifically, input acceptor/outputter 11 displays a determination result expressing either “normal” or “anomalous” based on the label information assigned to the real measurement signal. This makes it possible to present the determination result to the user.

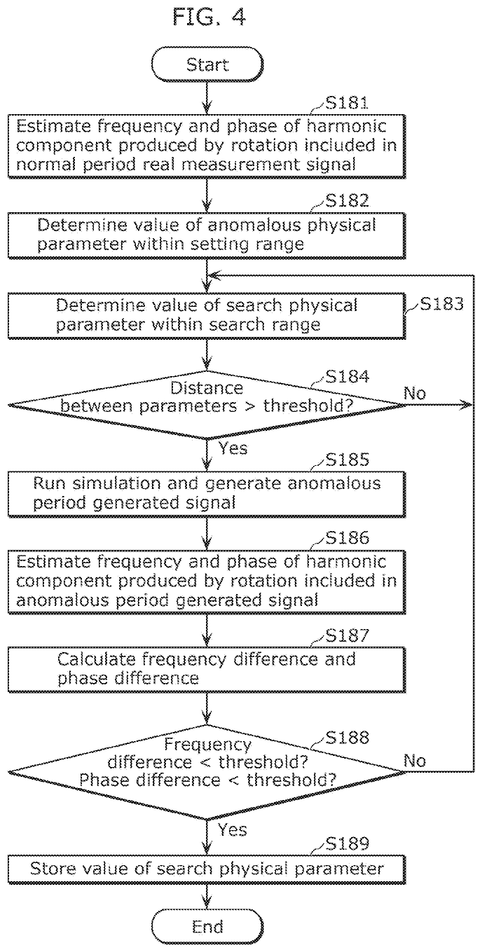

Next, if the determination result is “normal” (Yes in S16), composite signal generator 120 identifies a search physical parameter (S18). Specifically, composite signal generator 120 identifies the search physical parameter such that the frequencies and phases of the respective harmonic components of the normal period real measurement signal output from determiner 110 and the anomalous period generated signal output from simulator 130 match. A specific example of the identification processing will be described later with reference to FIG. 4.

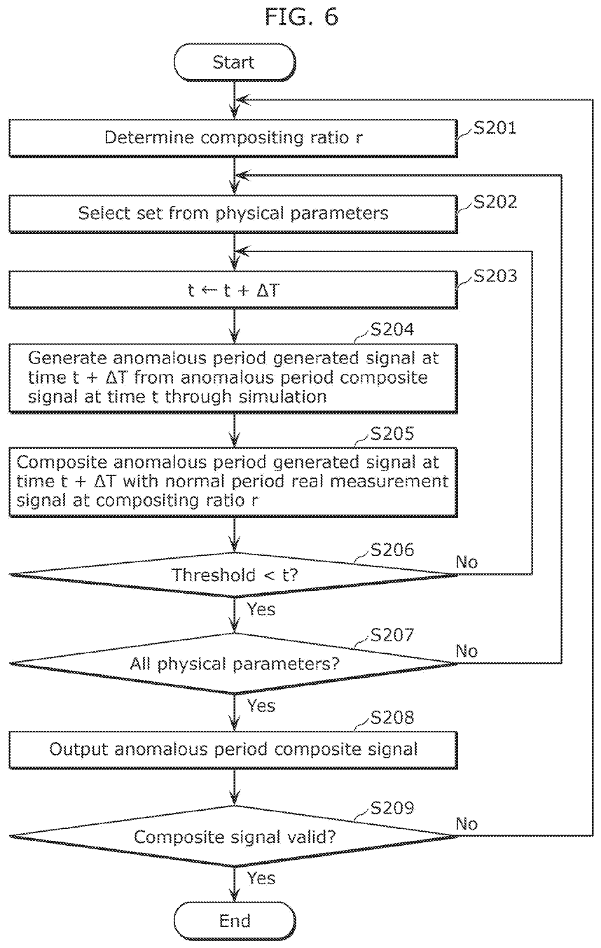

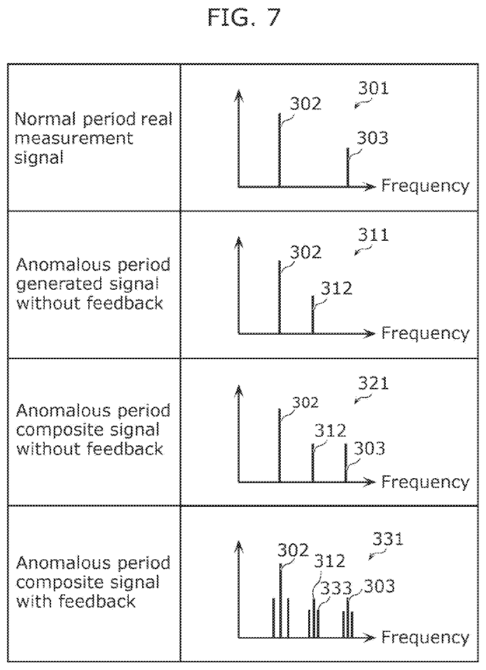

Next, composite signal generator 120 generates the anomalous period composite signal by compositing the normal period real measurement signal with the anomalous period generated signal (S20). A specific example of the compositing processing will be described later with reference to FIG. 6.

Next, learner 140 generates the anomaly location estimation model by performing machine learning using the anomalous period composite signal (S22). After generating the anomaly location estimation model, equipment state estimation device 10 performs the determination (S12) on the next real measurement signal and executes the processing from step S12 on.

On the other hand, if the determination result is “anomalous” (No in S16), anomaly location estimator 150 estimates the anomaly location in equipment 20 based on the anomalous period real measurement signal and the anomaly location estimation model (S24).

Next, input acceptor/outputter 11 outputs the anomaly location estimation result (S26). Specifically, input acceptor/outputter 11 can present the anomaly location in equipment 20 to the user by displaying the estimation result. Because the fact that an anomaly has occurred and the location of the anomaly is presented, the user can respond to the anomaly by, for example, performing maintenance on equipment 20, restoring equipment 20, or the like. Additionally, because the anomaly location is presented, the user can promptly consider and then execute the response, which makes it possible to reduce the time required for the response, increase the operating time, and increase the production efficiency.

After the estimation result is output, equipment state estimation device 10 ends the processing. Alternatively, equipment state estimation device 10 may perform the determination (S12) on the next real measurement signal and execute the processing from step S12 on.

### [2-1. Parameter Identification (S18)]

The specific processing for identifying the parameter (S18 in FIG. 3) among the operations by equipment state estimation device 10 according to the present embodiment will be described next with reference to FIG. 4. FIG. 4 is a flowchart illustrating processing pertaining to parameter identification among the operations performed by equipment state estimation device 10 according to the present embodiment.

To give an overview of the processing pertaining to parameter identification illustrated in FIG. 4, steps S181 and S182 are processing pertaining to initial setting, steps S183 and S184 are processing pertaining to the determination of the physical parameter, steps S185 to S188 are processing pertaining to the evaluation of the physical parameter, and step S189 is processing pertaining to the storage of the physical parameter.

First, feature estimator 121 estimates the frequency and the phase of the harmonic component produced by rotation included in the normal period real measurement signal (S181). The normal period real measurement signal may be selected from any one of a plurality of normal period real measurement signals output from determiner 110, or a plurality thereof may be selected. If a plurality of signals are selected, the processing of steps S181 to S189 is performed for each of the selected plurality of signals.

Next, parameter identifier 122 determines the value of the anomalous physical parameter within the setting range (S182). The setting range is a range set by the user through input acceptor/outputter 11. Parameter identifier 122 employs one value from within the setting range as the value of the anomalous physical parameter. At this time, parameter identifier 122 may determine the value of the new anomaly parameter with reference to the value of an anomalous physical parameter employed in the past. Additionally, the value of the anomalous parameter may be stochastically determined from a range set by the user.

Note that 0 may be included in the anomalous physical parameter setting range. An anomalous physical parameter value of 0 means that an anomaly has not occurred. In other words, if the simulation is performed using 0 as the value of the anomalous physical parameter, the generated data can be generated for the normal period rather than the anomalous period. Equipment state estimation device 10 may learn the normal period generated data through machine learning and generate a machine learning model to be utilized for the normal and/or anomalous determination and the like.

Next, parameter identifier 122 determines the value of the search physical parameter within the search range (S183). The search range is a search range set by the user through input acceptor/outputter 11. Parameter identifier 122 employs one value from within the search range as the value of the search physical parameter. At this time, parameter identifier 122 may determine the value of the new search physical parameter with reference to the value of a search physical parameter employed in the past or the frequency difference and/or phase difference calculated in step S187 (described later). Additionally, the value of the search physical parameter may be stochastically determined from a range set by the user.

Next, parameter identifier 122 evaluates a distance between the value of the determined search physical parameter and the value of the search physical parameter previously saved in step S189 (S184). If the distance is less than a preset threshold (No in S184), parameter identifier 122 determines the value of the search physical parameter again (S183). Through this, a value that is significantly different from the values determined in the past can be used for the subsequent processing. In other words, not performing the processing using a value close to values determined in the past makes it possible to comprehensively process various conditions while suppressing an increase in the amount of computation.

If the distance is greater than the preset threshold (Yes in S184), parameter identifier 122 outputs the values of each of the determined search physical parameter and anomalous physical parameter to simulator 130. Simulator 130 generates the anomalous period generated signal by performing a simulation using the search physical parameter, the anomalous physical parameter, the determined physical parameter, and the like (S185). Simulator 130 outputs the generated anomalous period generated signal to feature estimator 121.

Next, feature estimator 121 estimates the frequency and the phase of the harmonic component produced by rotation included in the anomalous period generated signal (S186).

Next, parameter identifier 122 calculates a frequency difference and a phase difference for the respective harmonic components produced by rotation included in each the normal period real measurement signal and the anomalous period generated signal (S187).

Next, parameter identifier 122 determines whether the calculated frequency difference and phase difference are less than corresponding thresholds set in advance (S188). If at least one of the frequency difference and the phase difference is not less than the threshold (No in S188), the sequence returns to step S183, where parameter identifier 122 determines the value of the search physical parameter again, and the subsequent processing is then repeated.

If both the frequency difference and the phase difference are less than the threshold (Yes in S188), parameter identifier 122 stores the value of the search physical parameter determined in step S183 in storage 12 (S189). Through this, when the search physical parameter stored in storage 12 is used in the simulation, simulator 130 can generate an anomalous period generated signal including a harmonic component having a frequency and a phase approximately equal to the frequency and the phase of the harmonic component included in the normal period real measurement signal. In other words, the anomalous period generated signal can reproduce the harmonic component produced by rotation in equipment 20.

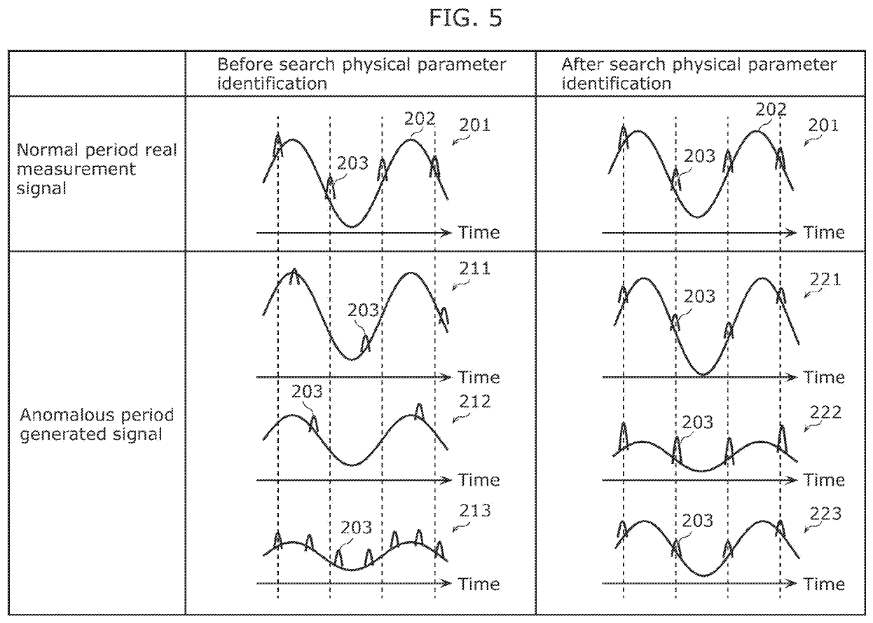

FIG. 5 is a diagram illustrating an example of the anomalous period generated signal generated by simulator 130 of equipment state estimation device 10 according to the present embodiment.

FIG. 5 illustrates normal period real measurement signal 201; anomalous period generated signals 211 to 213, from before the identification of the search physical parameter; and anomalous period generated signals 221 to 223, from after the identification of the search physical parameters. Here, an example will be described in which sensor 30 is a current sensor, and the real measurement signal and the generated signals are signals indicating a change in a current value over time. Each signal illustrated in FIG. 5 is represented as a graph in which the horizontal axis is defined as time and the vertical axis is defined as the current value. Anomalous period generated signals 211 to 213 are signals generated by simulating anomalies different from each other. The same applies to anomalous period generated signals 221 to 223.

Normal period real measurement signal 201 includes fundamental wave component 202 and harmonic component 203 produced by rotation. Generally, a motor provided in equipment 20 operates by non-linear interactions such as induced electromotive force, magnetic flux density, and/or current. A harmonic component and distortion produced by the rotation of the motor therefore appear in normal period real measurement signal 201 even in equipment 20 operating normally.

In anomalous period generated signals 211 to 213 before to the identification of the search physical parameter, at least one of the frequency and phase of harmonic component 203 produced by rotation is different from that in normal period real measurement signal 201. Note that the frequency of harmonic component 203 corresponds to the number of times harmonic component 203 appears in a predetermined period of time (e.g., 1 second), and is represented by an interval of harmonic component 203 in FIG. 5. The phase of harmonic component 203 corresponds to the time at which harmonic component 203 appears, and is represented by a position on the horizontal axis in FIG. 5.

If at least one of the frequency and phase is different, when compositor 123 composites normal period real measurement signal 201 with anomalous period generated signal 211, 212, or 213, the features of the frequency component specific to the anomaly in anomalous period generated signal 211, 212, or 213 cannot be sufficiently reflected in the anomalous period composite signal. This is because the feature of the anomaly location in equipment 20 is that the harmonic component produced by rotation and the frequency component specific to the anomaly appear in an overlapping frequency component.

In anomalous period generated signals 221 to 223 after the identification of the search physical parameter, the frequency and phase of harmonic component 203 produced by rotation substantially match the frequency and phase of harmonic component 203 included in normal period real measurement signal 201. Specifically, as indicated in step S188 of FIG. 4, the frequency difference and phase difference between normal period real measurement signal 201 and anomalous period generated signal 221, 222, or 223 are below the corresponding thresholds. In this case, by compositing normal period real measurement signal 201 with anomalous period generated signal 221, 222, or 223, compositor 123 can reproduce the frequency component where harmonic component 203 produced by rotation and the frequency component specific to the anomaly overlap.

Additionally, in step S188, only the frequency and phase of harmonic component 203 produced by rotation are evaluated. This makes it possible to generate anomalous period generated signals 221 to 223 having diverse features, which leads to generating diverse training data for the anomaly location estimation model.

### [2-2. Signal Compositing (Assimilation)]

The specific processing for compositing (S20 in FIG. 3) among the operations by equipment state estimation device 10 according to the present embodiment will be described next with reference to FIG. 6. FIG. 6 is a flowchart illustrating processing pertaining to compositing among the operations performed by equipment state estimation device 10 according to the present embodiment.

To give an overview of the processing pertaining to compositing illustrated in FIG. 6, steps S201 and S202 are processing pertaining to initial settings; steps S203 to S207 are processing pertaining to signal compositing; and steps S208 to S209 are processing for verifying the validity of the composite signal.

First, compositor 123 determines compositing ratio r (S201). The default value stored in storage 12 is used as compositing ratio r. Alternatively, a value input by the user through input acceptor/outputter 11 may be used as compositing ratio r.

Next, compositor 123 selects a set of search physical parameters identified in step S18 of FIG. 3 (specifically, the processing illustrated in FIG. 4) (S202). Specifically, by performing the identification processing illustrated in FIG. 4, a plurality of values are identified for each of the plurality of search physical parameters in storage 12. By referring to storage 12, compositor 123 selects an identified value for each search physical parameter, and takes the selected set of values as a set of search physical parameters. Note that when there is only one type of search physical parameter, compositor 123 determines the value of one type of search physical parameter.

Next, compositor 123 advances time t by ΔT (S203). Here, ΔT is an example of a predetermined period, and is a step time at the time the simulation is run. Time t+ΔT is an example of a second time that is a predetermined period after the first time. Reducing ΔT makes it possible to improve the accuracy of the simulation. Increasing ΔT makes it possible to reduce the number of times the simulation is run and reduce the amount of computation. Reducing the amount of computation can be expected to reduce the amount of power consumed. ΔT is set in advance and stored in storage 12. Alternatively, ΔT may be set by the user through input acceptor/outputter 11.

Next, simulator 130 runs a simulation and generates the anomalous period generated signal at time t+ΔT from the anomalous period composite signal at time t (S204). The simulation is run based on the following Formula (2), for example.

$${I}_{sim} ( t + Δ T ) = f ( {I}_{fusion} ( t ) ) \qquad ( 2 )$$

Here, I_{fusion}(t) is the anomalous period composite signal at time t. Iₛᵢₘ (t+ΔT) is the anomalous period generated signal at time t+ΔT. f( ) is a simulation model. The simulation model is created according to the type and value of each of the determined physical parameter, the search physical parameter, and the anomalous physical parameter. Using the anomalous period composite signal at time t makes it possible to generate an anomalous period generated signal including a frequency component overlapping with the harmonic component included in the normal period real measurement signal and the frequency component specific to the anomaly.

Next, compositor 123 composites the anomalous period generated signal at time t+ΔT with the normal period real measurement signal at time t+ΔT, at compositing ratio r (S205). The compositing is performed through weighted averaging as indicated in Formula (3) below, for example.

$${I}_{fusion} ( t + Δ T ) = r \times {I}_{sim} ( t + Δ T ) + ( 1 - r ) \times {I}_{real} ( t + Δ T ) \qquad ( 3 )$$

Here, Iᵣₑₐₗ (t+ΔT) is the normal period real measurement signal at time t+ΔT.

Next, compositor 123 determines whether time t is above a threshold set in advance (S206). The threshold here is set in advance as the length of the anomalous period composite signal required for the machine learning by learner 140, and is stored in storage 12. Alternatively, the threshold may be set by the user through input acceptor/outputter 11.

As long as time t is not greater than the threshold (No in S206), the processing of steps S203 to S205 is repeatedly executed. When time t is greater than the threshold (Yes in S206), compositor 123 determines whether the processing of steps S202 to S206 has been performed on all sets of search physical parameters identified in step S18 of FIG. 3 (specifically, the processing illustrated in FIG. 4) (S207). If even one set for which the processing has not been performed is present (No in S207), the sequence returns to S202, where a set not yet selected is selected, and the subsequent processing (S203 to S206) is executed thereon.

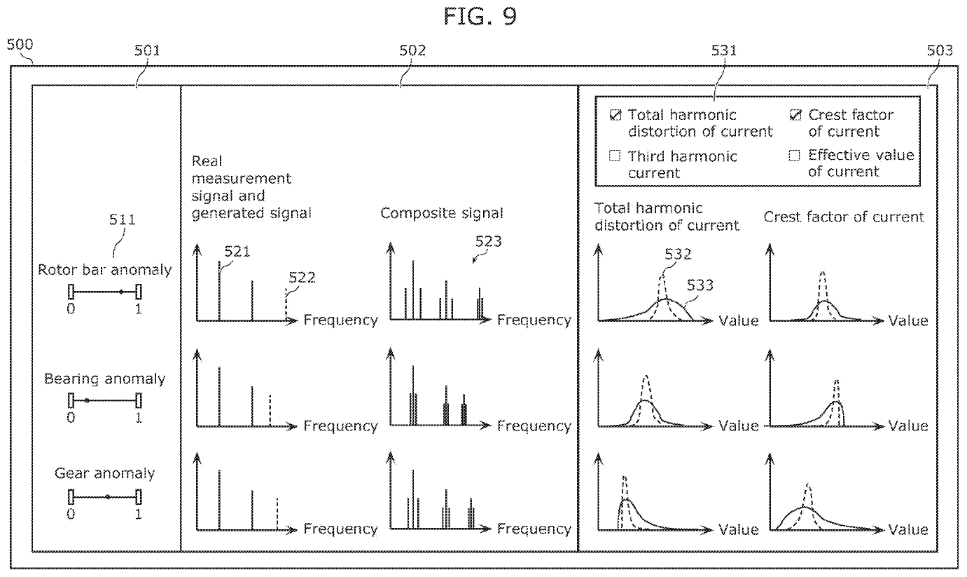

If the processing has been performed on all sets (Yes in S207), compositor 123 outputs the anomalous period composite signal to input acceptor/outputter 11 (S208). Input acceptor/outputter 11 displays the anomalous period composite signal generated by compositor 123. At this time, input acceptor/outputter 11 may display the anomalous period real measurement signal or the normal period real measurement signal side-by-side with the anomalous period composite signal, or superimposed on the anomalous period composite signal. This makes it possible to easily compare the anomalous period composite signal with the real measurement signal. A specific example of the display will be described later with reference to FIG. 9.

Next, compositor 123 determines whether the generated anomalous period composite signal is valid (S209). Specifically, compositor 123 determines whether the signal is valid based on the result of a determination made by the user, input through input acceptor/outputter 11. For example, the user confirms the anomalous period composite signal displayed in input acceptor/outputter 11 and evaluates the validity of the anomalous period composite signal. This evaluation is made, for example, based on the user's experience and/or a comparison with the specifications or the like of equipment 20. The user determines whether the anomalous period composite signal is valid, and inputs the result of the determination through input acceptor/outputter 11. Compositor 123 then determines whether the signal is valid based on the result of the determination input by the user. If the anomalous period composite signal is determined not to be valid (No in S209), the sequence returns to step S201, where compositor 123 determines compositing ratio r again and repeats the subsequent processing (S202 to S209). If the composite signal is determined to be valid (Yes in S209), the compositing processing ends.

FIG. 7 is a diagram illustrating an example of the anomalous period composite signal generated by compositor 123 of equipment state estimation device 10 according to the present embodiment.

FIG. 7 illustrates the results of performing frequency spectrum decomposition on each of normal period real measurement signal 301, anomalous period generated signal 311 without feedback, anomalous period composite signal 321 without feedback, and anomalous period composite signal 331 with feedback. Each signal is represented as a graph in which the horizontal axis is defined as the frequency and the vertical axis is defined as the signal strength.

As illustrated in FIG. 7, normal period real measurement signal 301 includes fundamental wave component 302 and harmonic component 303. Anomalous period generated signal 311 includes fundamental wave component 302 and anomaly-specific frequency component 312.

In FIG. 7, “without feedback” means that simulator 130 does not use the anomalous period composite signal. In other words, “without feedback” indicates a case where anomalous period generated signal 311 is generated by running a simulation without using the anomalous period composite signal at time t in step S204 of FIG. 6. On the other hand, “with feedback” means that simulator 130 uses the anomalous period composite signal. In other words, “with feedback” indicates a case where the anomalous period generated signal is generated according to the processing illustrated in FIG. 6.

Anomalous period composite signal 321 without feedback includes fundamental wave component 302, harmonic component 303, and anomaly-specific frequency component 312. However, anomalous period composite signal 331 with feedback includes fundamental wave component 302, harmonic component 303, anomaly-specific frequency component 312, and overlapping frequency component 333. Overlapping frequency component 333 is a frequency component in which harmonic component 303 included in normal period real measurement signal 301 and anomaly-specific frequency component 312 included in anomalous period generated signal 311 overlap.

If the anomalous period composite signal generated by compositor 123 is not fed back to simulator 130 in the processing of step S204 illustrated in FIG. 6, harmonic component 303 included in normal period real measurement signal 301 and anomaly-specific frequency component 312 included in anomalous period generated signal 311 are simply added together, resulting in anomalous period composite signal 321 illustrated in FIG. 7.

However, if the anomalous period composite signal generated by compositor 123 is fed back to simulator 130 in the processing of step S204 illustrated in FIG. 6 as in the present embodiment, in addition to harmonic component 303 included in normal period real measurement signal 301 and anomaly-specific frequency component 312 included in anomalous period generated signal, an anomalous period generated signal including a frequency component where harmonic component 303 and anomaly-specific frequency component 312 overlap can be generated. As a result, as illustrated in FIG. 7, anomalous period composite signal 331 including overlapping frequency component 333 is obtained.

In this manner, according to equipment state estimation device 10 according to the present embodiment, anomalous period composite signal 331 having non-linear features, such as the harmonic component overlapping with a frequency component specific to the anomaly, can be generated. This leads to generating diverse training data for the anomaly location estimation model.

### [3. Physical Parameter Input/Output Screen]

An example of physical parameter input/output screen will be described next with reference to FIG. 8.

FIG. 8 is a diagram illustrating an example of a physical parameter input/output screen displayed by input acceptor/outputter 11 of equipment state estimation device 10 according to the present embodiment. As illustrated in FIG. 8, input/output screen 400 includes determined physical parameter setting area 401, anomalous physical parameter setting area 402, and search physical parameter setting area 403.

Parameter value input box 411 is displayed in determined physical parameter setting area 401. Parameter value input box 411 is provided for each type of determined physical parameter. Parameter value input box 411 is a text box that accepts the input of text (numbers) from the user. For example, the user inputs the value of the determined physical parameter into parameter value input box 411. Note that various GUI objects, such as a list box, radio buttons, a slider, or the like, may be used instead of a text box.

Lower limit value input box 421 and upper limit value input box 422 are displayed in anomalous physical parameter setting area 402. Lower limit value input box 421 and upper limit value input box 422 are provided for each type of anomalous physical parameter. Lower limit value input box 421 and upper limit value input box 422 are both text boxes that accept the input of text (numbers) from the user. For example, the user inputs a range to which the anomalous physical parameter can be set (specifically, an upper limit value and a lower limit value) into lower limit value input box 421 and upper limit value input box 422. Note that various GUI objects, such as a list box, radio buttons, a slider, or the like, may be used instead of a text box.

Lower limit value input box 431 and upper limit value input box 432 are displayed in search physical parameter setting area 403. Lower limit value input box 431 and upper limit value input box 432 are provided for each type of search physical parameter. Lower limit value input box 431 and upper limit value input box 432 are both text boxes that accept the input of text (numbers) from the user. For example, the user inputs a search range for the search physical parameter (specifically, an upper limit value and a lower limit value) into lower limit value input box 431 and upper limit value input box 432. Note that various GUI objects, such as a list box, radio buttons, a slider, or the like, may be used instead of a text box.

Additionally, search result 433 is displayed in search physical parameter setting area 403. Search result 433 is a histogram showing the distribution of search physical parameters identified in step S18 of FIG. 3. Note that the display format of search result 433 is not limited to a graph such as a histogram.

Displaying search result 433 enables the user to evaluate whether the search physical parameter identification result is valid. If the search physical parameter identification result is not valid, the search physical parameter identification can be performed again by changing a value such as the upper limit value or the lower limit value of the search physical parameter.

In this manner, in the present embodiment, input acceptor/outputter 11 accepts the input of the value of the determined physical parameter through input/output screen 400. Input acceptor/outputter 11 also accepts inputs for the search range of the search physical parameter. Input acceptor/outputter 11 also accepts inputs for the setting range of the anomalous physical parameter. Input acceptor/outputter 11 also outputs the identified search physical parameter. Note that the configuration of input/output screen 400 illustrated in FIG. 8 is merely an example, and the configuration is not limited to the example illustrated. In addition, although input/output using a GUI displayed on a screen is described here as an example, input acceptor/outputter 11 may accept input of information through other input means, such as voice input. In addition, the information received by input acceptor/outputter 11 and the information output are not limited to the foregoing example.

### [4. Compositing Result Display Screen]

An example of a compositing result display screen will be described next with reference to FIG. 9.

FIG. 9 is a diagram illustrating an example of a screen displaying a GUI object for inputting a compositing ratio and a compositing result, displayed by input acceptor/outputter 11 of equipment state estimation device 10 according to the present embodiment. As illustrated in FIG. 9, display screen 500 includes compositing ratio setting area 501, frequency spectrum display area 502, and signal feature display area 503.

Compositing ratio input bar 511 is displayed in compositing ratio setting area 501. Compositing ratio input bar 511 is provided for each type of anomalous physical parameter (anomaly location). Compositing ratio input bar 511 is a slider that accepts the input of compositing ratio r from the user. For example, the user can view the details displayed in frequency spectrum display area 502 and/or signal feature display area 503, and set the value of compositing ratio r for each anomaly location using compositing ratio input bar 511. Note that various GUI objects, such as a text box, a list box, radio buttons, or the like, may be used instead of a slider.

The frequency spectra of normal period real measurement signal 521, anomalous period generated signal 522, and anomalous period composite signal 523 are displayed in frequency spectrum display area 502 for each anomaly location. Normal period real measurement signal 521 (the solid line) and anomalous period generated signal 522 (the broken line) are superimposed on the same graph.

By comparing the frequency spectra displayed in frequency spectrum display area 502, the user can confirm that the compositing performed in step S205 of FIG. 6 has enabled a frequency component in which the harmonic component produced by rotation and the frequency component specific to the anomaly overlap to be reproduced in anomalous period composite signal 523.

Signal feature selection box 531 and distributions of the signal features of anomalous period real measurement signal 532 and anomalous period composite signal 533 are displayed in signal feature display area 503. Signal feature selection box 531 is a checkbox through which the user can select a signal feature to display. The signal feature is a feature determined based on a change in a physical quantity over time (here, current) measured by sensor 30. For example, the user displays the distribution of the signal feature of anomalous period real measurement signal 532 and the distribution of the signal feature of anomalous period composite signal 533 according to the feature selected in signal feature selection box 531. Anomalous period real measurement signal 532 may be displayed for each anomaly location, and the same distribution may be displayed at each anomaly location regardless of the anomaly location.

Comparing the distributions of the features enables the user to confirm whether various anomalous period composite signals are successfully generated by compositing the normal period real measurement signal with the anomalous period generated signal. Because the anomalous period composite signal is used as training data for machine learning, diverse anomalies can be assumed to have occurred when diverse anomalous period composite signals are successfully generated, which makes it possible to improve the accuracy of the anomaly location estimation model.

In this manner, in the present embodiment, input acceptor/outputter 11 accepts the input of the compositing ratio through display screen 500. Input acceptor/outputter 11 also outputs (displays) various signals such as the anomalous period generated signal, the anomalous period composite signal, the normal period real measurement signal, and the like. Note that the configuration of display screen 500 illustrated in FIG. 9 is merely an example, and the configuration is not limited to the example illustrated. In addition, although input/output using a GUI displayed on a screen is described here as an example, input acceptor/outputter 11 may accept input of information through other input means, such as voice input. In addition, the information received by input acceptor/outputter 11 and the information output are not limited to the foregoing example.

As described above, according to equipment state estimation device 10 according to the present embodiment, a variety of anomalous period data reproducing even non-linear features can be generated even when not enough anomalous period data is available. Equipment state estimation device 10 can therefore estimate the location of an anomaly with high accuracy.

### (Other)

Although an equipment state estimation device, an equipment state estimation method, and the like according to one or more aspects have been described above based on various embodiments with reference to the drawings, it goes without saying that the present disclosure is not limited to these embodiments. Variations on or modifications of the present embodiment conceived by one skilled in the art and embodiments implemented by combining constituent elements from different other embodiments, for as long as they do not depart from the essential spirit thereof, fall within the scope of the present disclosure.

For example, the method through which devices (e.g., equipment state estimation device 10 and sensor 30) communicate with each other described in the foregoing embodiment is not particularly limited. When devices communicate wirelessly, the wireless communication method (communication standard) is short-range wireless communication such as ZigBee (registered trademark), Bluetooth (registered trademark), wireless LAN (Local Area Network), or the like, for example. Alternatively, the wireless communication method (communication standard) may be communication over a wide-area communication network such as the Internet. Alternatively, wired communication may be used among the devices instead of wireless communication. Specifically, the wired communication is power line communication (PLC) or communication using a wired LAN.

Additionally, processing executed by a specific processing unit in the foregoing embodiment may be executed by a different processing unit. Additionally, the order of multiple processes may be changed, or multiple processes may be executed in parallel. Additionally, the distribution of the constituent elements provided in equipment state estimation system 1 throughout the plurality of devices is merely one example. For example, constituent elements provided in one device may be provided in another device. The equipment state estimation system may also be implemented as a single device.

For example, the processing described in the foregoing embodiment may be implemented through centralized processing using a single device (system), or may be implemented through distributed processing using a plurality of devices. Additionally, a single processor or a plurality of processors may execute the above-described programs. In other words, the processing may be centralized processing or distributed processing.

Additionally, in the foregoing embodiment, all or some of the constituent elements such as controllers and the like may be constituted by dedicated hardware, or may be implemented by executing software programs corresponding to those constituent elements. Each constituent element may be implemented by a program executor such as a central processing unit (CPU) or a processor reading out and executing a software program recorded on a recording medium such as an HDD or semiconductor memory.

Additionally, the function blocks used in the descriptions of the foregoing embodiment are typically implemented through Large-Scale Integration (LSI), which is a type of integrated circuit. The integrated circuit controls each function block used in the descriptions of the foregoing embodiment, and may include an input acceptor and an outputter. These devices can be implemented individually as single chips, or may be implemented with a single chip including some or all of the devices. Although the term “LSI” is used here, other names, such as IC, system LSI, super LSI, ultra LSI, the like are used depending on the degree of integration.

Furthermore, the manner in which the circuit integration is achieved is not limited to LSI, and it is also possible to use a dedicated circuit or a generic processor. It is also possible to employ a FPGA (Field Programmable Gate Array) which is programmable after the LSI circuit has been manufactured, or a reconfigurable processor in which the connections or settings of the circuit cells within the LSI circuit can be reconfigured.

Furthermore, if other technologies that improve upon or are derived from semiconductor technology enable integration technology to replace LSI circuits, then naturally it is also possible to integrate the function blocks using that technology. For example, biotechnology and optical integrated circuits are one such foreseeable example.

The general or specific forms of the present disclosure may be implemented as systems, devices, methods, integrated circuits, or computer programs. These forms may instead be implemented by a computer-readable non-transitory recording medium, such as an optical disk, an HDD, semiconductor memory, or the like, in which the computer program is stored. These forms may also be implemented by any desired combination of systems, devices, methods, integrated circuits, computer programs, and recording media.

Additionally, many changes, substitutions, additions, omissions, and the like are possible for the foregoing embodiments without departing from the scope of the claims or a scope equivalent thereto.

### INDUSTRIAL APPLICABILITY

The present disclosure can be used as a device and method for estimating the state of equipment, and is useful in diagnostic systems and the like for detecting anomalies such as equipment failures, estimating anomaly locations, and the like, for example.

1. An equipment state estimation device comprising:
a determiner that determines whether a real measurement signal obtained by measuring an operation state of equipment is normal or anomalous;
a simulator that generates an anomalous period generated signal by simulating an anomaly in the equipment;
a compositor that generates an anomalous period composite signal by compositing the anomalous period generated signal with a normal period real measurement signal that is a real measurement signal determined to be normal by the determiner;
a learner that generates a learning model for estimating an anomaly location in the equipment by performing machine learning using the anomalous period composite signal; and
a first estimator that estimates the anomaly location in the equipment based on the learning model and an anomalous period real measurement signal that is a real measurement signal determined to be anomalous by the determiner,
wherein the simulator generates the anomalous period generated signal using the anomalous period composite signal.

2. The equipment state estimation device according to claim 1, further comprising:
a second estimator that estimates a frequency and a phase of a harmonic component included in the normal period real measurement signal as a first frequency and a first phase; and
an identifier that identifies a first physical parameter of the equipment based on the first frequency and the first phase,
wherein the simulator performs the simulating using the first physical parameter identified by the identifier.

3. The equipment state estimation device according to claim 2,
wherein the second estimator further estimates a frequency and a phase of a harmonic component included in the anomalous period generated signal as a second frequency and a second phase, and
the identifier identifies the first physical parameter to cause a frequency difference and a phase difference to each be less than a corresponding threshold, the frequency difference being a difference between the first frequency and the second frequency, and the phase difference being a difference between the first phase and the second phase.

4. The equipment state estimation device according to claim 2, further comprising:
an input acceptor that accepts an input of a search range for the first physical parameter,
wherein the identifier identifies the first physical parameter within the search range.

5. The equipment state estimation device according to claim 4,
wherein the input acceptor accepts an input of a value of a second physical parameter of a type different from the first physical parameter, and
the second estimator estimates the first frequency and the first phase using the value accepted by the input acceptor.

6. The equipment state estimation device according to claim 4, further comprising:
an outputter that outputs the first physical parameter identified by the identifier.

7. The equipment state estimation device according to claim 4,
wherein the input acceptor accepts an input of a setting range for an anomalous parameter of the equipment, and
the simulator generates the anomalous period generated signal by performing the simulating within the setting range for the anomalous parameter.

8. The equipment state estimation device according to claim 1,
wherein by performing the simulating using the anomalous period composite signal from a first time, the simulator generates the anomalous period generated signal for a second time that is a predetermined period after the first time.

9. The equipment state estimation device according to claim 1, further comprising:
an input acceptor that accepts an input of a compositing ratio between the normal period real measurement signal and the anomalous period generated signal,
wherein the compositor generates the anomalous period composite signal by compositing the normal period real measurement signal and the anomalous period generated signal at the compositing ratio.

10. The equipment state estimation device according to claim 1, further comprising:
an outputter that outputs the normal period real measurement signal, the anomalous period generated signal, and the anomalous period composite signal.

11. An equipment state estimation method comprising:
determining whether a real measurement signal obtained by measuring an operation state of equipment is normal or anomalous;
generating an anomalous period generated signal by simulating an anomaly in the equipment;
generating an anomalous period composite signal by compositing the anomalous period generated signal with a normal period real measurement signal that is a real measurement signal determined to be normal;
generating a learning model for estimating an anomaly location in the equipment by performing machine learning using the anomalous period composite signal; and
estimating the anomaly location in the equipment based on the learning model and an anomalous period real measurement signal that is a real measurement signal determined to be anomalous,
wherein the generating of the anomalous period generated signal includes generating the anomalous period generated signal using the anomalous period composite signal.

12. A non-transitory computer-readable recording medium having recorded thereon a program that causes a computer to execute the equipment state estimation method according to claim 11.
